(19) United States
(12) Patent Application Publication
(10) Pub. No.: US 2026/0344764 A1
(43) Pub. Date: Nov. 5, 2026

(54) HEATER FOR AN AEROSOL PROVISION DEVICE

(71) Applicant: Nicoventures Trading Limited, London (GB)

(72) Inventors: Tom WOODMAN, London (GB); Juan Esteban Paz JAUREGUI, London (GB); Mark POTTER, London (GB); Theodora NANNOU, London (GB)

(21) Appl. No.: 19/125,414

(22) PCT Filed: Oct. 24, 2023
(86) PCT No.: PCT/EP2023/079626

§ 371 Date: Apr. 29, 2025

(30) Foreign Application Priority Data
Oct. 31, 2022 (GB) 2216085.7

(51) Int. Cl. A24F 40/46; A24F 40/20; A24F 40/70

(52) U.S. Cl. CPC A24F 40/46; A24F 40/70; A24F 40/20

(57) ABSTRACT

The application relates to a heater for an aerosol provision device. The heater is configured to heat an article comprising aerosol generating material. The heater has an elongate housing having a housing body, an open end and a closed end. A heating element extends in the housing in the direction of the longitudinal axis, wherein the housing comprises a deformed portion forming the closed end.

### CROSS-REFERENCE TO RELATED APPLICATIONS

This present application is a National Phase entry of PCT Application No. PCT/EP2023/079626, filed 24 Oct. 2023, which claims priority from Great Britain Application No. 2216085.7, filed 31 Oct. 2022, each of which are fully incorporated herein by reference in their entireties.

### TECHNICAL FIELD

The present invention relates to a heater for an aerosol provision device, an aerosol provision device, an aerosol provision system and a method of forming a heater for an aerosol provision device.

### BACKGROUND

Smoking articles such as cigarettes, cigars and the like burn tobacco during use to create tobacco smoke. Attempts have been made to provide alternatives to these articles by creating products that release compounds without combusting. Examples of such products are so-called “heat not burn” products or tobacco heating devices or products, which release compounds by heating, but not burning, material. The material may be, for example, tobacco or other non-tobacco products, which may or may not contain nicotine.

Aerosol provision systems, which cover the aforementioned devices or products, are known. Common systems use heaters to create an aerosol from a suitable medium which is then inhaled by a user. Often the medium used needs to be replaced or changed to provide a different aerosol for inhalation. It is known to use resistive heating systems as heaters to create an aerosol from a suitable medium. Separately, induction heating systems are known to be used as heaters.

### SUMMARY

According to an aspect, there is provided a heater for an aerosol provision device configured to heat an article containing aerosol generating material, comprising: an elongate housing having a housing body, an open end and a closed end; a heating element extending in the housing in the direction of a longitudinal axis of the housing; wherein the housing comprises a deformed portion forming the closed end.

The open end may define a base end of the housing, the closed end may define a free end of the housing, and the deformed portion may define the free end.

The housing body may extend between the base end and the free end, wherein the deformed portion may extend from the housing body.

The housing body may define an undeformed portion of the housing at the free end and the deformed portion may abut the undeformed portion.

The deformed portion may comprise at least two deformed sections in abutment with each other to form the closed end.

The deformed portion may comprise at least three deformed sections to form the closed end.

The at least two deformed sections may be in abutment with each other at a location intermediate to opposing sides of the housing body.

The housing body may define a void.

The housing body is tubular.

The tubular housing body may have a circular cross-section.

The tubular housing body may have an oval cross section.

The tubular housing body may have a prismatic shape.

The tubular housing body may be a polyhedron.

The tubular housing body may have a square cross section.

The tubular housing body may have a hexagonal cross section.

The tubular housing body may be a polygonal cross section that has chamfered corners.

The tubular housing body may be a polygonal cross section that has rounded corners.

The tubular housing body may have a square cross section that has chamfered corners.

The tubular housing body may have a cross section comprising at least one straight edge and one curved edge. The deformed portion may converge in a direction from the base end to the free end.

The deformed portion may define an apex.

The deformed portion may at least substantially define one of a conical, frustoconical, pyramidical, or frusto-pyramidical shape.

The tip may have a prismatic shape.

The deformed portion may define a ridge.

The deformed portion may define a blade-like end.

The deformed portion may define a flat end.

The deformed portion may comprise a crimped portion.

The deformed portion may comprise a fold.

The tip may have a substantially or fully planar surface or domed surface.

The substantially or fully planar surface may extend perpendicular to the longitudinal axis.

A juncture between the tip and the housing body may comprise a rounded edge.

The juncture between the tip and the housing body may comprise a chamfer.

The juncture may define part of the tip.

The dimensions of the housing adjacent the open end may be greater than the dimensions of the housing at the closed end.

At least one dimension perpendicular to the longitudinal axis of the housing adjacent the open end may be greater than the dimensions of the housing at the closed end.

The heater may comprise a seal at the closed end to seal the deformed portion.

The seal may be positioned within the deformed portion.

The housing body may comprise three or more longitudinally extending faces.

Each deformed section may extend from an end of each of the longitudinally extending faces.

A cross-section perpendicular to the longitudinal axis of the housing body may have the shape of at least one of a regular polygon and an irregular polygon.

A radially outer edge of the cross-section may have the shape of at least one of a regular polygon and an irregular polygon.

The housing may have a cross-section perpendicular to the longitudinal axis of the housing has the shape of an irregular polygon.

At least one face of the housing body may have a curved shape.

A cross-section of the housing body perpendicular to the longitudinal axis of the housing may have an oval or elliptical shape.

The housing may be formed from a material of about uniform thickness.

The housing may be formed from stainless steel.

The deformed portion may be formed from stainless steel.

The undeformed portion may be formed from stainless steel.

The housing may be formed from aluminium.

The deformed portion may be formed from aluminium.

The undeformed portion may be formed from aluminium. The housing may define a first volume within which the heating element is disposed, the heating element may be configured such that it defines a second volume, wherein the first and second volumes may be approximately the same shape.

The housing may be formed from a material of non-uniform thickness.

The cross-sectional shape of a radially inner face of the housing body may be a different shape to the cross-sectional shape of a radially outer face of the housing body.

The cross-sectional shape of the radially inner face of the housing body perpendicular to the longitudinal axis may be circular.

The housing may comprises an outer surface; at least a part of the outer surface of the housing may support a coating. The coating may have a lower coefficient of friction than the outer surface of the housing.

The coating may comprise a low friction material.

The coating may comprise a vitreous layer.

The vitreous layer may be at least one of a vitreous glaze and a vitreous enamel layer.

The coating may have a thickness of less than 200 μm, less than 100 μm, or less than 50 μm.

At least 50%, at least 70%, or at least 80% of the area of the outer surface of the housing may support the low friction material.

The coating may extend over the deformed portion.

The heater may be a resistive heating heater.

The heating element may be a resistive heating element.

The heating element may comprise a heating coil.

The heating coil may be a resistive heating heater coil

The heater may be an inductive heating heater.

The heating element may be an inductive heating element.

The coil may be an inductive coil.

According to an aspect, there is provided a heater for use in an aerosol-generating device configured to heat an aerosol generating article to generate an aerosol, comprising: an elongate housing; a heating element in the housing; wherein the housing has a non-circular cross-section perpendicular to the longitudinal axis of the housing.

The heater may be configured to be used in an aerosol provision device. According an aspect, there is provided an aerosol provision device configured to heat an article comprising aerosol generating material, the device comprising a heater of any described above. The aerosol provision device may comprise a heating chamber, in which the heater provided.

The aerosol provision device may comprise a power source, a controller and a heating chamber, in which the aerosol generating article is removeable received. The power source may be aligned along a longitudinal axis of the heating chamber. The power source may be aligned along a second longitudinal axis, parallel to the longitudinal axis of the heating chamber.

The aerosol provision device may be configured for wireless charging.

According to an aspect there is provided an aerosol provision system comprising: an aerosol provision device of any described above; and an article comprising aerosol generating material.

The aerosol provision system may comprise a charging unit having a cavity for removably receiving the aerosol provision device. The charging unit may comprise a moveable lid, which covers the aerosol provision device in a closed configuration. The charging unit may comprise a user display. The user display may be visible to a user when the moveable lid is in a closed position and is partially or fully concealed or obscured from sight by the lid when the lid is an open position.

According to an aspect, there is provided a method of forming heater for an aerosol provision device comprising: providing an elongate housing; inserting a heating element in the elongate housing; and deforming one end of the housing to form a closed end of the housing.

The heating element may be inserted prior to the one end of the housing being deformed.

The one end of the housing may be deformed prior to the heating element being inserted in the elongate housing.

According to an aspect there is provided a method of generating aerosol comprising: providing an aerosol provision device configured to heat an article comprising aerosol generating material, the device comprising a heater described above. at least partially inserting an aerosol generating article into the receiving portion of the heating chamber.

### BRIEF DESCRIPTION OF THE DRAWINGS

Various embodiments will now be described, by way of example only, and with reference to the accompanying drawings, in which:

FIG. 1 shows a perspective view of an aerosol provision system including an aerosol provision device located within a charging unit;

FIG. 2 shows a schematic cross-sectional view of part of the aerosol provision device of FIG. 1;

FIG. 3 shows a schematic cross-sectional view of part of the aerosol provision device of FIG. 1 and an aerosol generating article of the aerosol provision system;

FIG. 4 shows a perspective view of another aerosol provision device;

FIG. 5 shows a schematic cross-sectional view of the device of FIG. 4;

FIG. 6 shows a schematic cross-sectional view of a heater of the device of FIG. 1 or FIG. 4;

FIG. 7 shows a perspective view of a deformed portion of the housing;

FIG. 8 shows a schematic cross-sectional view of a heater of the device of FIG. 1 or FIG. 4 according to various embodiments; and

FIG. 9 shows a schematic cross-sectional view of a heater of the device of FIG. 1 or FIG. 4.

### DETAILED DESCRIPTION

According to the present disclosure, a “non-combustible” aerosol provision system is one where a constituent aerosol-generating material of the aerosol provision system (or component thereof) is not combusted or burned in order to facilitate delivery of at least one substance to a user.

In some embodiments, the delivery system is a non-combustible aerosol provision system, such as a powered non-combustible aerosol provision system.

In some embodiments, the non-combustible aerosol provision system is an electronic cigarette, also known as a vaping device or electronic nicotine delivery system (END), although it is noted that the presence of nicotine in the aerosol-generating material is not a requirement.

In some embodiments, the non-combustible aerosol provision system is an aerosol-generating material heating system, also known as a heat-not-burn system. An example of such a system is a tobacco heating system.

In some embodiments, the non-combustible aerosol provision system is a hybrid system to generate aerosol using a combination of aerosol-generating materials, one or a plurality of which may be heated. Each of the aerosol-generating materials may be, for example, in the form of a solid, liquid or gel and may or may not contain nicotine. In some embodiments, the hybrid system comprises a liquid or gel aerosol-generating material and a solid aerosol-generating material. The solid aerosol-generating material may comprise, for example, tobacco or a non-tobacco product.

Typically, the non-combustible aerosol provision system may comprise a non-combustible aerosol provision device and a consumable for use with the non-combustible aerosol provision device.

In some embodiments, the non-combustible aerosol provision device may comprise an area for receiving the consumable, an aerosol generator, an aerosol generation area, a housing, a mouthpiece, a filter and/or an aerosol-modifying agent. In some embodiments, the consumable for use with the non-combustible aerosol provision device may comprise aerosol-generating material, an aerosol-generating material storage area, an aerosol-generating material transfer component, an aerosol generator, an aerosol generation area, a housing, a wrapper, a filter, a mouthpiece, and/or an aerosol-modifying agent.

As used herein, the term “aerosol-generating material” is a material that is capable of generating aerosol, for example when heated, irradiated or energized in any other way. Aerosol-generating material may, for example, be in the form of a solid, liquid or semi-solid (such as a gel) which may or may not contain an active substance and/or flavourants.

The aerosol-generating material may comprise one or more active substances and/or flavours, one or more aerosol-former materials, and optionally one or more other functional material.

The aerosol-generating material may comprise a binder, such as a gelling agent, and an aerosol former. Optionally, a substance to be delivered and/or filler may also be present. Optionally, a solvent, such as water, is also present and one or more other components of the aerosol-generating material may or may not be soluble in the solvent. In some embodiments, the aerosol-generating material is substantially free from botanical material. In particular, in some embodiments, the aerosol-generating material is substantially tobacco free.

The aerosol-generating material may comprise or be in the form of an aerosol-generating film. The aerosol-generating film may comprise a binder, such as a gelling agent, and an aerosol former. Optionally, a substance to be delivered and/or filler may also be present. The aerosol-generating film may be substantially free from botanical material. In particular, in some embodiments, the aerosol-generating material is substantially tobacco free.

The aerosol-generating film may have a thickness of about 0.015 mm to about 1 mm. For example, the thickness may be in the range of about 0.05 mm, 0.1 mm or 0.15 mm to about 0.5 mm or 0.3 mm.

The aerosol-generating film may be continuous. For example, the film may comprise or be a continuous sheet of material. The sheet may be in the form of a wrapper, it may be gathered to form a gathered sheet or it may be shredded to form a shredded sheet. The shredded sheet may comprise one or more strands or strips of aerosol-generating material.

The aerosol-generating film may be discontinuous. For example, the aerosol-generating film may comprise one or more discrete portions or regions of aerosol-generating material, such as dots, stripes or lines, which may be supported on a support. In such embodiments, the support may be planar or non-planar.

The aerosol-generating film may be formed by combining a binder, such as a gelling agent, with a solvent, such as water, an aerosol-former and one or more other components, such as one or more substances to be delivered, to form a slurry and then heating the slurry to volatilise at least some of the solvent to form the aerosol-generating film.

An aerosol provision device can receive an article comprising aerosol generating material for heating. An “article” in this context is a component that includes or contains in use the aerosol generating material, which is heated to volatilise the aerosol generating material, and optionally other components in use.

A user may insert the article into or onto the aerosol provision device before it is heated to produce an aerosol, which the user subsequently inhales. The article may be, for example, of a predetermined or specific size that is configured to be placed within or over a heater of the device which is sized to receive the article.

An aerosol generator is an apparatus configured to cause aerosol to be generated from the aerosol-generating material. In some embodiments, the aerosol generator is a heater configured to subject the aerosol-generating material to heat energy, so as to release one or more volatiles from the aerosol-generating material to form an aerosol.

A consumable is an article comprising or consisting of aerosol-generating material, part or all of which is intended to be consumed during use by a user. A consumable may comprise one or more other components, such as an aerosol generating material storage area, an aerosol-generating material transfer component, an aerosol generation area, a housing, a wrapper, a mouthpiece, a filter and/or an aerosol-modifying agent. A consumable may also comprise an aerosol generator, such as a heater, that emits heat to cause the aerosol-generating material to generate aerosol in use. The heater may, for example, comprise combustible material, a material heatable by electrical conduction, or a susceptor.

A susceptor is a heating material that is heatable by penetration with a varying magnetic field, such as an alternating magnetic field. The susceptor may be an electrically-conductive material, so that penetration thereof with a varying magnetic field causes induction heating of the heating material. The heating material may be magnetic material, so that penetration thereof with a varying magnetic field causes magnetic hysteresis heating of the heating material. The susceptor may be both electrically-conductive and magnetic, so that the susceptor is heatable by both heating mechanisms. The aerosol provision device that is configured to generate the varying magnetic field is referred to as a magnetic field generator, herein.

Non-combustible aerosol provision systems may comprise a modular assembly including both a reusable aerosol provision device and a replaceable aerosol generating article. In some implementations, the non-combustible aerosol provision device may comprise a power source and a controller (or control circuitry). The power source may, for example, comprise an electric power source, such as a battery or rechargeable battery. In some implementations, the non-combustible aerosol provision device may also comprise an aerosol generating component. However, in other implementations the aerosol generating article may comprise partially, or entirely, the aerosol generating component.

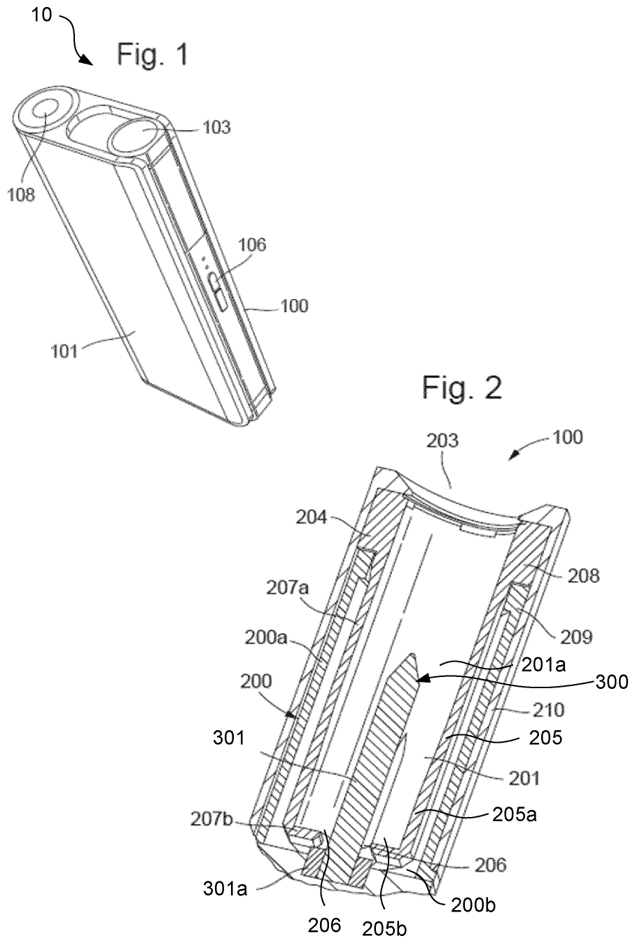

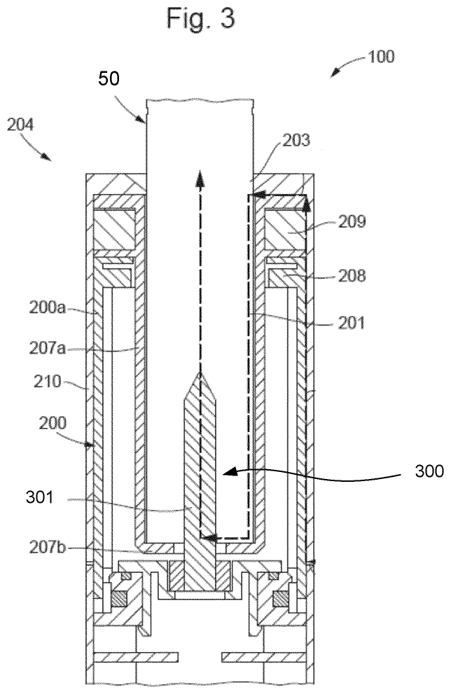

FIG. 1 shows an aerosol provision system 10 comprising an aerosol provision device 100 and a charging unit 101. The device is shown located within a cavity of a charging unit 101. The aerosol provision device 100 is arranged to generate aerosol from an aerosol generating article (refer to FIG. 3) which may be inserted, in use, into the aerosol provision device 100. In embodiments, the article forms part of the aerosol provision system 10.

The aerosol provision device 100 is an elongate structure, extending along a longitudinal axis. Additionally, the aerosol provision device has a proximal end, which will be closest to the user (e.g. the user's mouth) when in use by the user to inhale the aerosol generated by the aerosol provision device 100, as well as a distal end which will be furthest from the user when in use. The proximal end may also be referred to as the “mouth end”. The aerosol provision device 100 also accordingly defines a proximal direction, which is directed towards the user when in use. Further, the aerosol provision device 100 also likewise defines a distal direction, which is directed away from the user when in use. The terms proximal and distal as applied to features of the device 100 will be described by reference to the relative positioning of such features with respect to each other in a proximal-distal direction along a longitudinal axis. The aerosol provision device 100 comprises an opening at the distal end, leading into a heating chamber.

The aerosol provision device 100 may be removably inserted into the charging unit 101 in order to be charged. The charging unit 101 comprises a cavity (refer to FIG. 2) for receiving the aerosol provision device 100. The aerosol provision device 100 may be inserted into the cavity via an opening. The cavity may also comprise a longitudinal opening. A portion of the aerosol provision device 100 may comprise a first side. One or more user-operable control elements such as buttons 106 which can be used to operate the aerosol provision device 100 may be provided on the first side of the aerosol provision device 100. The first side of the aerosol provision device 100 may be received in the longitudinal opening provided in the charging unit 101.

In embodiments the cavity of the charging unit 101 may have a cross-sectional profile which only permits that the aerosol provision device 100 be inserted into the charging unit 101 in a single orientation. According to an embodiment the outer profile of the aerosol provision device 100 may comprise an arcuate portion and a linear portion. The cross-sectional profile of the cavity provided in the charging unit 101 may also comprise a similar arcuate portion and a linear portion. The linear portion of the cross-sectional profile of the cavity may correspond with the longitudinal opening.

The charging unit 101 includes a slidable lid 103. When the aerosol provision device 100 is inserted into the charging unit 101 in order to be recharged, the slidable lid 103 may be closed so as to cover the opening into the aerosol provision device 100. In other embodiments, the charging unit 101 may have an alternative lid configuration, such as a hinged or pivoted lid, or no lid may be provided.

The charging unit 101 may include a user interface such as display 108, which can be provided at any convenient location, such as in the position shown in FIG. 1.

FIG. 2 schematically shows a cross sectional view of a portion of the aerosol provision device 100. The aerosol provision device 100 comprises a main housing 200. The main housing 200 defines a device body of the device 100. The device 100 defines a heating chamber 201. A receptacle 205 defines the heating chamber 201. An opening 203 is provided to provide access to the heating chamber 201. The receptacle 205 comprises a wall arrangement including a receptacle side wall 205a and a receptacle base 205b. The base 205b is at the distal end of the receptacle 205. A heating zone 201a is configured to receive at least a portion of the article for heating.

A heating member 301 is provided in a portion of the main housing 200 and the heating member 301 extends or projects into the heating chamber 201. The heating member 301 may comprise a base portion 301a which may be located in a recess provided in a portion of the body of the device 100. The heating member 301 upstands in the heating chamber 201. The heating member 301 upstands from the distal end.

The heating member 301 comprises an elongate heating member in the form of a pin. The heating member 301 in other embodiments comprises other elongate configurations, such as a blade. The heating member 301 is inserted, in use, into a distal end of an aerosol generating article 50 (refer to FIG. 3) which is received within the heating chamber 201 in order to internally heat the aerosol generating article.

The housing comprises housing wall 200a. The housing wall 200a extends along the longitudinal axis of the aerosol provision device 100, surrounding the heating chamber 201. The housing wall 200a may, at least in part, define a receiving chamber of the aerosol provision device 100, as the volume which is enclosed within the wall 200a. A housing base 200b is at the distal end of the housing wall 200a. In the shown embodiment, the heating member 301 upstands from the housing base 200b. The heating member 301 protrudes through the receptacle base 205b. An aperture 206 is formed in the receptacle base 205b through which the heating member 301 protrudes. In embodiments, the heating member 301 is mounted to the receptacle base 205b. The heating member 301 upstands from the receptacle base 205b.

The aerosol provision device 100 further comprises a removal mechanism 204 which may be removably retained to the main housing 200 of the aerosol provision device 100. The removal mechanism 204 in embodiments is omitted. In embodiments, the housing wall 200a at least in part defines the receptacle 205. The removal mechanism 204 may be retained to the main housing 200 so that at least a portion of the removal mechanism 204 extends into the heating chamber 201. The removal mechanism 204 may comprise a longitudinal portion such as a peripheral wall portion 207a, which in the present embodiment is tubular, and a base wall portion 207b. The wall 207a may be a shape other than tubular, and may be any shape which encloses (e.g. encircles) and defines the heating chamber 201 there within.

In embodiments with the removal mechanism 204, the removal mechanism 204 defines the heating chamber 201. The removal mechanism 204 forms the receptacle 205. In embodiments in which the removal mechanism 204 is omitted, other features of the device 100 define the heating chamber 201, for example the housing side wall 200a and housing base 200b.

The base portion 207b has the aperture 206 through which the heating member 301 may project. In order to retain the removal mechanism 204 to the main housing 200, the removal mechanism 204 is pushed into engagement with the main housing 200 in the distal direction, i.e. towards the distal end of the main housing 200, until the removal mechanism 204 is able to move no further in the distal direction. In the following description, when the removal mechanism 204 is referred to as being “retained to” the main housing 200, this is when the removal mechanism 204 is engaged with the main housing 200, and can move no further in the distal direction.

Together, the peripheral portion 207a and the base portion 207b may define and enclose an article chamber for receiving, the aerosol generating article 50, as shown in FIG. 3. The article chamber comprises an inner surface, which is configured to contact the aerosol generating article, the inner surface comprising a longitudinally extending portion which is provided by the tubular portion 207a, and an end portion which is provided by the base portion 207b. In embodiments, the article chamber and the heating chamber are the same. When the aerosol generating article 50 is received in the heating chamber, it may contact both the longitudinally extending portion of the inner surface, and the end portion of the inner surface. In particular, the article chamber (i.e. the peripheral portion 207a and the base portion 207b) may be configured to receive at least part of the aerosol generating article 50 which is in the form of rod which is longitudinally extending and cylindrical, such that the longitudinal axis of the article is parallel to (and optionally in line with) the longitudinal axis of the aerosol provision device 100 when received in the article chamber.

The article chamber may also be referred to as a receiving portion. When the removal mechanism 204 is retained to the main housing 200, in use, the article chamber of the removal mechanism 204 is arranged, at least partially, within the heating chamber 201. The heating member 301 may be arranged so as to project into the article chamber, through the aperture 206 provided in the base portion 207b of the removal mechanism 204. The removal mechanism 204 is therefore configured to receive at least a portion of the aerosol generating article in use.

In embodiments, the removal mechanism 204 may comprise a first magnet or a magnetisable material 208. The main housing 200 may comprise a second magnet or magnetisable material 209. In use, the removal mechanism 204 may be magnetically retained to the main housing 200 by the interaction of the first magnet or magnetisable material 208 and the second magnet or magnetisable material 209.

In embodiments, the removal mechanism 204 is fully detachable from the main housing 200. The removal mechanism 204 may be retained to the main housing 200 by a magnetic force of attraction between the first magnet or magnetisable material 208 and the second magnet or magnetisable material 209. The removal mechanism 204 may be detached from the main housing 200 by overcoming the magnetic force between the first magnet or magnetisable material 208 and the second magnet or magnetisable material 209. In embodiments, the removal mechanism 204 is removably retained to the main housing 200 by other means. For example, the removal mechanism 204 may be configured to be removably retained to the main housing 200 by an interference fit with the main housing.

The removal mechanism 204 may comprise an internal element (comprising the tubular portion 207a and a base portion 207b) and an outer cap portion 210, wherein when retained to the main housing 200 the outer cap portion 210 encapsulates (e.g. covers) at least a portion of the main housing 200, such as the wall 200a of the main housing. The tubular portion 207a, base portion 207b and outer cap portion 210 may comprise an integral (e.g. unitary) component (formed, for example, by moulding). Alternatively, the tubular portion 207a and base portion 207b may comprise a first component and the outer cap portion 210 may comprise a second separate component. The first and second components may then be secured together.

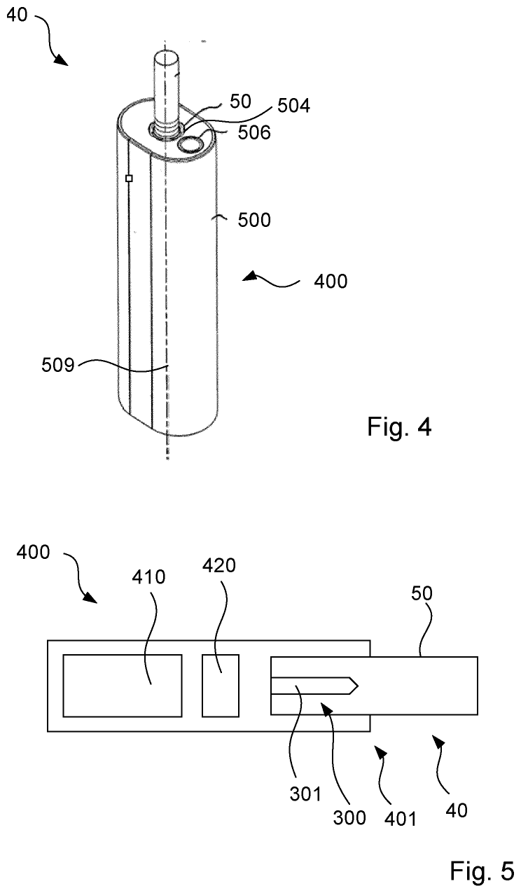

FIG. 4 shows another aerosol provision system 40. The system 40 comprises a one-piece aerosol provision device 400 for generating aerosol from an aerosol generating material, and the aerosol generating article 50 comprising the aerosol generating material. The device 400 can be used to heat the aerosol generating article 50 comprising the aerosol generating material, to generate an aerosol or other inhalable medium which can be inhaled by a user of the device 400.

The device 400 comprises a housing 500 which surrounds and houses various components of the device 400. The housing 500 is elongate. The device 400 has an opening 504 in one end, through which the article 50 can be inserted for heating by the device 400. The article 50 may be fully or partially inserted into the device 400 for heating by the device 400.

The device 400 may comprise a user-operable control element 506, such as a button or switch, which operates the device 400 when operated, e.g. pressed. For example, a user may activate the device 400 by pressing the switch 406.

The device 400 defines a longitudinal axis 509 along which an article 50 may extend when inserted into the device 400. The opening 504 is aligned on the longitudinal axis 509.

FIG. 5 shows a cross-sectional schematic view of the aerosol provision system 40. Features described with reference to FIG. 5 in embodiments are applicable to embodiments described above. The aerosol provision device 400 comprises a power source 410, a controller 420 and a heating chamber 401, in which the aerosol generating article 50 is removeable received.

The one-piece device of FIG. 5 shows the power source 410 aligned along the longitudinal axis of the heating chamber 401. In another embodiment of a one-piece aerosol generating device, the power source is aligned along a second longitudinal axis, parallel to the longitudinal axis of the heating chamber.

The heating member 301 comprises an elongate heating member in the form of a pin. The heating member 301 in embodiments comprises other elongate configurations, such as a blade. The heating member 301 is provided in the heating chamber. The heating member 301 of FIG. 5 and the heating member 301 described above with reference to FIGS. 1 to 3, such that details described herein may be applied to each. The heating member 301 extends or projects into the heating chamber 401.

The heating member 301 may be inserted, in use, into a distal end of the aerosol generating article which is received within the heating chamber 401 in order to internally heat the aerosol generating article.

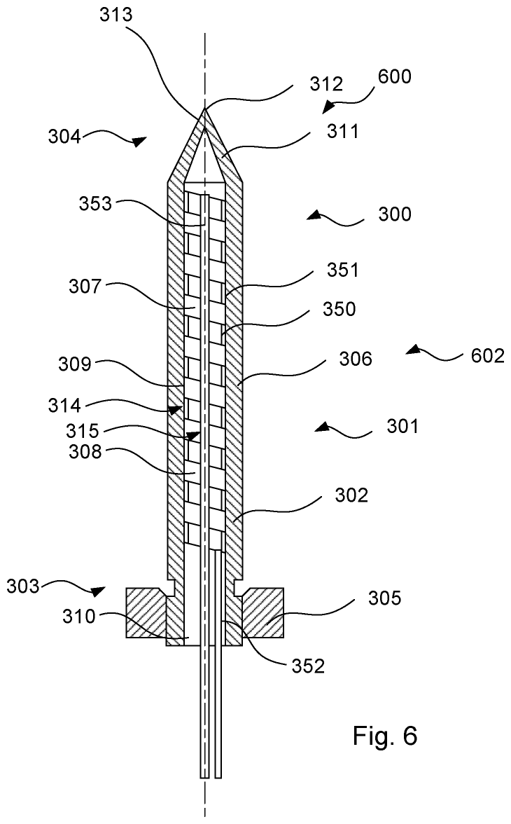

The aerosol provision devices 100, 400 comprise a heating arrangement 300. The heating arrangement 300 comprises a heater. The heating member 301 acts as the heater. The heater comprises a heating element 350 (refer to FIG. 6), such as a resistive heating coil, arranged to be actuated to heat the heating member 301.

The heating arrangement 300 is a resistive heating arrangement. The heater is a resistive heating heater. The heating element, such as a heating coil, as will be described below is a resistive heating element. In such arrangements the heating assembly comprises a resistive heating generator including components to heat the heating element via a resistive heating process. In this case, an electrical current is directly applied to a resistive heating element, and the resulting flow of current in the heating element, acting as a heating component, causes the heating element to be heated by Joule heating. The resistive heating element comprises resistive material configured to generate heat when a suitable electrical current passes through it, and the heating arrangement comprises electrical contacts for supplying electrical current to the resistive material. In embodiments, the heating element forms at least part of the resistive heating member itself. In embodiments the resistive heating element transfers heat to the heating member, for example by conduction. The provision of a resistive heating arrangement allows for a compact arrangement. Resistive heating provides an efficient configuration.

FIG. 6 shows the heating member 301 for use in an aerosol provision device as described above. The heating member 301 acts as or forms at least part of a heater. The heating arrangement 300 comprises the heating member 301. The heating member 301 comprises an elongate housing 302 and the heating element 350. The elongate housing 302 is an elongate member defining a longitudinal axis.

The elongate housing 302 is formed from a thermally conductive material, such as aluminium. Other suitable materials, such as stainless steel or ceramic may be used. The elongate housing may comprise a coating on its outer surface. The elongate housing 302 is configured to transfer heat from the heating element 350 to the heating zone 201a.

The elongate housing 302 has a base end 303 and a free end 304. The base end 304 mounts to the device body. A mount 305 at the base end 303 mounts the heating member 301. It will be understood that different mounting arrangements may be used, for example a fixing, moulding, and bonding including adhering. The mount 305 may be a separate component or may be integrally formed with the elongate housing 302.

The elongate housing 302 comprises a housing body 306. The housing body 306 is tubular. The housing body 306 comprises a bore 307. The bore 307 defines an inner void 308 of the heating member 301. The inner void 308 extends longitudinally. In embodiments, the inner void 308 is at least partially filled, for example with a filler. In embodiments, the inner void 308 is completely filled, for example with one or more fillers and/or components. In embodiments, the inner void 308 defines an air gap. An inner surface 309 is defined on an inner side of the elongate housing 302. An open end 310 to the inner void 308 is provided at the base end 303.

The free end 304 of the elongate housing 302 extends towards the proximal end of the heating chamber. The free end 304 of the heating member 301 is closed. The free end 304 is a closed end 313. The inner void 308 does not extend through the free end 304. A tip 311 is provided at the free end 304. The tip 311 extends to an apex 312.

The heating element 350 extends in the heating member 301. The heating element 350 extends in the elongate housing 302 in the longitudinal direction. The heating element 350 is received in the inner void 308. The heating element 350 extends between the base end 303 and the distal end 304. In embodiments, the heating element extends partially along the length of the inner void 308. In embodiments the heating element 350 extends to or beyond the open end 310.

The heating element 350 in embodiments comprises a heating coil 351. The heating coil 351 comprises a resistive member defining the heating coil 351. In embodiments the heating coil 351 comprises an electrically insulative coating, such as a ceramic, to electrically insulate the heating coil 351 from the elongate housing 302. The electrically insulative coating in embodiments is thermally conductive to provide for heat transfer from the heating element 350 to the elongate housing 302. In embodiments the electrically insulative coating is omitted. In embodiments, a separate electrically insulative arrangement, such as at least one of an electrically insulative member and an electrically insulative filler is provided. The electrically insulative member and electrically insulative filler in embodiments is thermally conductive to provide for heat transfer from the heating element 350 to the elongate housing 302.

The heating coil 351 is a resistive heating coil. The heating coil 351 is a helical coil. The heating coil 351 has a rectangular cross-sectional profile. It will be understood that other coil configurations are possible. In embodiments, the heating coil 351 has a circular cross-sectional profile. In embodiments, the heating arrangement 300 comprises two or more heating coils.

The heating arrangement 300 comprises electrical connection paths. The electrical connection paths extend from each end of the heating element 350. A base electrical connection path 352 extends from the distal end of the heating element 350. A return electrical connection path 353 extends from the proximal end of the heating element 350. The return electrical connection path overlaps the longitudinal extent of the heating element 350. The electrical connection paths are integrally formed with the heating element, for example as a single wire. In embodiments, connectors connect the electrical connection paths with the heating element 350. The heating coil 351 is formed from a resistive material, such as a nickel/chrome alloy such as nichrome 80/20(80% Nickel, 20% Chromium), an iron/chrome/aluminium alloy, or a copper/nickel alloy.

A cross-section perpendicular to the longitudinal axis at any point along the length of the housing 302 is a regular shape. In the shown embodiment, the elongate housing 302 has a circular cross section. The housing body 306 is cylindrical and the free end 304 of the elongate housing 302 is conical. The tip 311 is conical. Other shapes and configurations of the tip 311 may be provided, for example the tip 311 may define a substantially or fully planar surface or domed surface. The substantially or fully planar surface extends perpendicular to the longitudinal axis in embodiments. The tip 311, for example, may define a frustoconical, pyramidical, or frusto-pyramidical shape. In embodiments, the tip 311 has a prismatic shape.

A juncture between the tip 311 and the housing body 306 in embodiments comprises a rounded edge. The juncture between the tip 311 and the housing body 306 in embodiments comprises a chamfer. The juncture in embodiments defines part of the tip 311.

The elongate housing 302 is formed with a wall of non-uniform thickness. The wall thickness of the elongate housing decreases towards the tip 311. The wall thickness and/or thickness profile of the housing body 306 and the tip 311 differs in embodiments. For example, the wall thickness of at least part of the tip may be less than the wall thickness of the housing body 306 to aid deformation of that section.

The elongate housing converges towards the tip 311. In embodiments, the elongate housing 302 is formed with a wall of uniform thickness. In embodiments, the wall thickness of the elongate housing increases towards the tip 311.

The elongate housing 302 defines a first volume 314 within which the heating coil 351 is disposed, the heating coil 351 being configured such that it defines a second volume 315, wherein the first and second volumes 314, 315 are approximately the same shape. The inner void 308 is the same shape as the heating coil 351. It can be appreciated that the elongate housing 302 may be any appropriate shape. In embodiments of the cross section perpendicular to the longitudinal axis of the elongate housing 302 may vary along the length of the elongate housing 302. The cross-section may have the shape of a regular polygon and/or an irregular polygon. The dimensions of the cross section perpendicular to the longitudinal axis of the elongate housing 302 may vary along the extent of the elongate housing 302. The maximum diameter of the elongate housing 302 may decrease between the base end 303 and the free end 304 such that the elongate housing 302 converges. The greatest diameter of the elongate housing 302 may be found at a location intermediate the base and the free end 304 of the housing 302. The elongate housing 302 may be formed from a material of about uniform thickness.

The housing body 306 may be any appropriate shape. In the shown embodiment a cross-section perpendicular to the longitudinal axis of the housing body 306 has a circular shape. The housing body 306 is generally cylindrical. In embodiments, at least one face of the housing body 306 has a curved shape. In embodiments, a cross-section of the housing body 306 perpendicular to the longitudinal axis of the housing 302 has the shape of at least one of a regular polygon and an irregular polygon. In embodiments, a cross-section of the housing body 306 perpendicular to the longitudinal axis of the housing 302 may have an oval or elliptical shape. In embodiments, the cross-sectional shape of a radially inner face of the housing body 306 is a different shape to the cross-sectional shape of a radially outer face of the housing body 306. In other words the housing 302 has a non-uniform arrangement. In embodiments, the cross-sectional shape of the radially inner face of the housing body 306 perpendicular to the longitudinal axis may be circular. In embodiments, the housing body 306 has a prismatic shape. The housing body 306 may be a polyhedron. The housing body 306 may be a polygonal cross section that has chamfered corners. The housing body 306 may be a polygonal cross section that has rounded corners. The housing body 306 may have a cross section comprising at least one straight edge and one curved edge.

With reference to FIGS. 6 to 9, the tip 311 of elongate housing 302 of the heating member 301 further comprises a deformed portion 600 and an undeformed portion 602. The deformed portion 600 forms the closed end 313.

‘Deformed’ in the context of this document is intended to describe a subsequent condition of any feature of a component that has been manipulated following formation. Such a feature may include a part, portion, piece, section, segment or tranche of a component. A deformed portion may have been at least one of bent, shapened, compressed, extended, distorted, curved, flexed, buckled, and crimped, for example during a deforming process of a preformed component. This deformation occurs after an initial component forming, such as casting or molding of the component. A deformed feature or component is one which has undergone some kind of previous deformation in order to change its shape and/or physical properties. ‘Undeformed’ is intended to describe any feature of a component that was not ‘deformed’ during the assembly of the device, that is free from a manipulation following the initial formation process.

The housing body 306 defines the undeformed portion. The undeformed portion 602 is at the distal end of the heating chamber. The undeformed portion 602 defines the base end 303 of the housing 302. The undeformed portion 602 defines the open end 310 of the housing 302. The undeformed portion 602 extends from the base end 303 of the housing 302 towards the free end 304 of the housing 302. The deformed portion 600 extends from the undeformed portion 602 of the housing 302.

The undeformed portion 602 extends from the base end 303 of the housing 302 to the deformed portion 600. The undeformed portion 602 and the deformed portion 600 are unitary. The undeformed portion 602 and the deformed portion 600 form a one-piece component. The undeformed portion houses the heating member.

The tip 311 defines the deformed portion 600. The deformed portion 600 defines the distal end of the housing 302. The deformed portion 600 defines the free end 304 of the housing 302. The deformed portion 600 forms the closed end 313 of the elongate housing 302. The deformed portion 600 has been subjected to a deforming process to form the closed end 313.

The tip 311 converges to the apex 312. The wall thickness of material of the deformed portion 600 decreases as the tip 311 converges towards the apex 312. The wall thickness of material of the deformed portion is less than the wall thickness of material of the undeformed portion 602. In embodiments, the wall thickness of material of the deformed portion 600 is uniform. In embodiments, the wall thickness of material of the deformed portion 600 may be the same as the thickness of material of the undeformed portion 602.

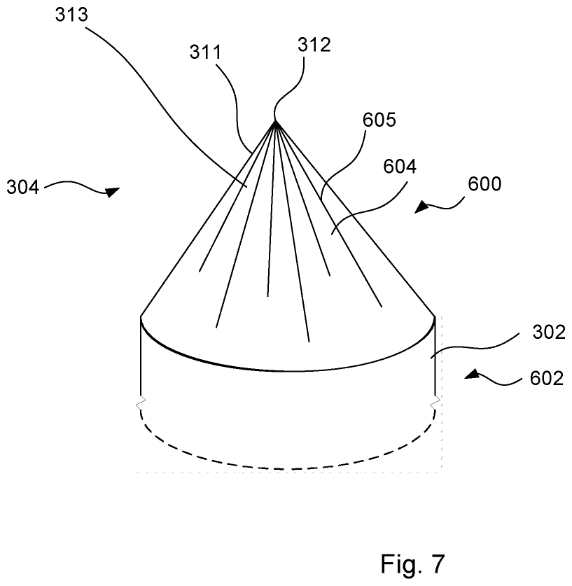

In FIGS. 7, 8 and 9 the deformed portion 600 is shown according to various embodiments.

FIG. 7 shows the closed end 313 similar to the closed end 313 of the heating member 301 of FIG. 6 wherein the elongate housing 302 has been deformed. The elongate housing 302 has been deformed to form the closed end 313. In FIG. 7 the deformed portion 600 comprises a crimped portion 605. The free end 304 of the housing 302 has been deformed by a crimping process.

The crimped portion 605 is formed by pinching circumferentially at the free end 304. In embodiments, the crimped pattern may be a regular, uniform pattern. The crimped portion 605 may define impressions at the closed end. Deforming the elongated housing 602 in this manner provides an increased surface area in contact with the article 50. An increased surface contact between the heating arrangement and the article 50 increases the efficiency of heat energy transfer. The increased efficiency would shorten the time taken to aerosolize the aerosol generating material in the article 50. This improves the user experience of the device 400.

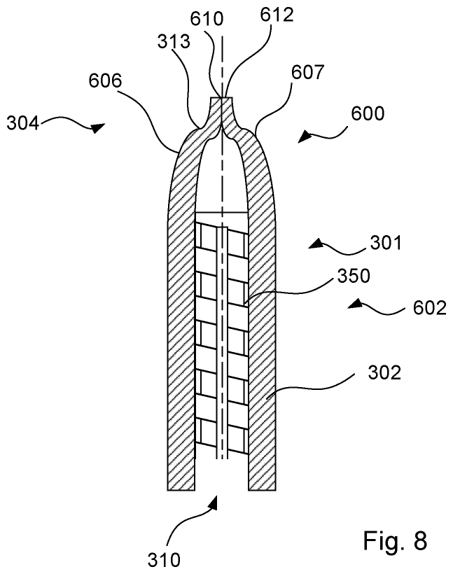

FIG. 8 shows an embodiment of the closed end 313 in which the deformed portion 600 comprises a first deformed section 606 and a second deformed section 607. The number of deformed sections may differ and may be three or more sections. The first and second deformed sections 606, 607 converge, such that the free end 304 is closed. The first and second deformed sections 606, 607 define an end of the inner void 308. The first and second deformed sections 606, 607 abut each other to form the closed end 313. The first and second deformed sections 606, 607 abut each other at a location intermediate the opposing sides of the housing 302. The deformed portion 600 forms a ridge 612. The deformed portion 600 forms a blade-like end. The deformed portion 600 forms a flat end. The deformed sections 606, 607 may be crimped. In embodiments, the deformed sections are folded to overlap each other.

In embodiments the deformed portion 600 comprises three or more deformed sections 606, 607 brought into abutment at a location intermediate the three sides of the housing. Un-manipulated sections prior to deformation to become deformed sections may be defined by a preceding process step, such as a cutting, stamping, or moulding process. The deformed portion 600 may define a conical, frustoconical, pyramidical, or frusto-pyramidical shape.

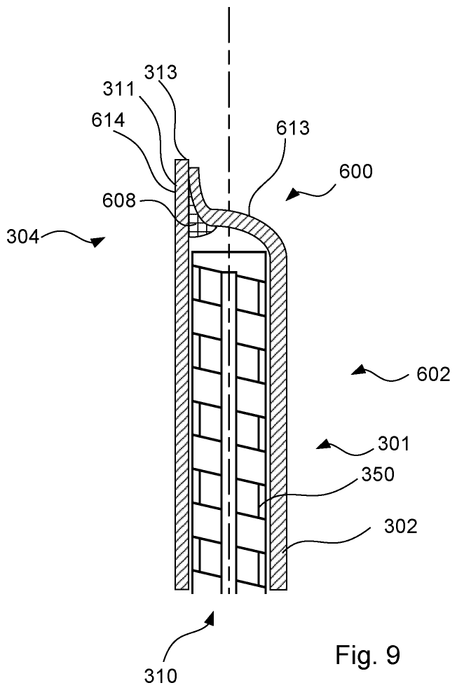

FIG. 9 shows an embodiment of the closed end 313 in which the deformed portion 600 abuts an undeformed portion 614 of the elongate housing 302. The undeformed portion 614 is on the opposite side of the elongate housing 302 to the deformed portion 600. The deformed portion is defined by one or more deformed sections 613.

The deformed section 613 abuts the undeformed portion 614 of the elongate housing 302. The deformed portion 600 forms the closed end 313 with the undeformed portion 614. The undeformed portion and deformed portion are on opposing sides. The deformed section 613 and the undeformed portion 614 abut each other to form the closed end 313. The deformed section 613 and the undeformed side 614 abut each other at the location of the opposite side 614 of the housing 302. Deforming the elongated housing in this way enables the housing to act as a guide member insertion of the article 50 and/or for guiding the article 50 into the heating chamber 401 correctly (refer to FIG. 4). This embodiment of forming the closed end 313 of the elongate housing 302 also advantageously simplifies assembly of the device as only deformation of one side of the housing is required. Advantageously deformation is only required in a single direction. Advantageously, the housing does not need to be manufactured with a closed end 313 before assembly of the heating member 301 or the device, but can instead be formed during assembly. The closed end 313 can be formed during assembly before or after insertion of the heating element 350.

The elongate housing 302 can be deformed in any of the ways described and shown. In embodiments, for example, the elongate housing can define a deformed portion 600 in which a blade-like, ridge 612 also comprises a crimped section 605. Any combination of deformation actions can be taken to produce the closed end 313 of the elongate housing 302.

The closed end 313 is configured such that fluids and/or particulates are restricted from enter the inner void 308. The closed end is fluidly sealed. In embodiments, the deformation itself forms the fluid seal. In embodiments, a sealing member is provided. In FIG. 9, a seal member 608 is disposed at the closed end 313 to seal the deformed portion 600. The seal member 608 can be disposed in any of the shown embodiments of the invention. The seal restricts entry of liquids and/or particulates into the inner void 308. The seal is disposed within the deformed portion 600. In embodiments the seal may be formed during the forming of the deformed portion 600. The deformed portion may comprise a fold. The fold may be at least a 180-degree fold. In embodiments the closed end 313 may be sealed or welded closed. In embodiments, the seal 608 may be disposed in the undeformed portion 602. Sealing the housing aids the operational life of the heating arrangement. Intrusion of fluid and/or particulates could decrease the efficiency of the heating element 350.

The undeformed portion 602 and the deformed portion 600 are formed from the same material, such as aluminium 316. Such a material aids with thermal conductivity and ease of deformation. Other suitable materials may be used, for example stainless steel. Such a material aids with mechanical strength. In other embodiments, the undeformed portion 602 and the deformed portion 600 may be formed from different materials. The deformed and undeformed portions may be formed from any appropriate material or combination of materials.

A portion of the outer surface of the elongate housing 302 is coated. The coating has a lower coefficient of friction than the outer surface of the housing 302. At least the deformed section 604 of the housing 302 supports the coating. The coating enables the article 50 to more easily slide against the elongate housing 302. The coating reduces the likelihood of the article 50 getting stuck within the device, in particular over a deformed portion. The coating comprises a vitreous layer. The coating has a thickness of less than 200 μm. The coating is a vitreous glaze. The coating comprises a vitreous enamel layer. The coating in embodiments is a vitreous substance bonded on the housing body 306. In embodiments, the coating may be any other suitable coating.

The coating aids the provision of a surface that enables self-cleaning upon insertion of an article 50 into the heating chamber 201. The coating helps to provide protection to the surface of the heating member 301. The coating helps to provide protection to the surface of the heating member 301 from corrosion.

In embodiments, at least the housing body 306 supports the coating. In embodiments, at least 50%, and/or at least 70%, and/or at least 80% of the area of the outer surface of the housing 302 supports the low friction material. The coating enables easier insertion and removal of the article 50 onto the heating member 301. The coating improves the longevity of the heating member 301 by reducing abrasion between the article 50 and the heating member 301 during insertion of the article 50 into the device.

During assembly of the device, the elongate housing 302 is provided, initially undeformed. In a method of assembly of the heating component 301, the elongate housing 302 only defines an undeformed portion. The heating element 350 is inserted into the elongate housing 302. The heating element 350 is inserted into the free end 304 of the elongate housing 302. The free end 304 of the elongate housing 302 is then deformed, defining a deformed portion 600 and an undeformed portion. The elongate housing 302 is deformed to close the free end 304. The free end 304 defines a closed end. In embodiments, the heating element 350 may be inserted into the base end 303 of the housing. The heating element 350 may be inserted before the elongate housing 302 has been deformed. As such, the heating element may be inserted from the free end 304. This may aid assembly. In embodiments, the heating element is inserted after the elongate housing 302 has been deformed. A complex shape at the tip 311 of the elongate housing does not need to be produced initially as it may be formed by the deformation process. The standard of the manufacturing equipment and quality control at the manufacturing stage may not need to be as high, saving initial set up manufacturing costs.

In the above described embodiments, the heating arrangement is a resistive heating arrangement. In embodiments, other types of heating arrangement are used, such as inductive heating. With such an arrangement, a low-resistive or non-resistive material may be used to form the heating coil 351. The configuration of the device is generally as described above and so a detailed description will be omitted.

An inductive heating arrangement comprises various components to heat the aerosol generating material of the article via an inductive heating process. Induction heating is a process of heating an electrically conducting heating member (such as a susceptor) by electromagnetic induction. An induction heating arrangement may comprise an inductive element, for example, one or more inductor coils, and a device for passing a varying electric current, such as an alternating electric current, through the inductive element. The varying electric current in the inductive element produces a varying magnetic field. The varying magnetic field penetrates a susceptor (heating member) suitably positioned with respect to the inductive element. In inductive heating, as compared to heating by conduction for example, heat is generated inside the susceptor, allowing for rapid heating. Further, there need not be any physical contact between the inductive element and the susceptor, allowing for enhanced freedom in construction and application.

In inductive heating heat is generated in the susceptor (heating member) whereas in resistive heating heat is generated in the coil (heating element).

In embodiments, the heating member of the aerosol provision system is a part of the aerosol generating article, rather than being a part of the aerosol provision device. The heating element may be a resistive heating element, for example in the form of the resistive coil described above, which is provided as part of the aerosol generating article. Electrical connections may enable electric current to flow through the resistive heating element.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the invention as defined by the claims or limitations on equivalents to the claims, and that other embodiments may be utilised and modifications may be made without departing from the scope of the claimed invention. Various embodiments of the invention may suitably comprise, consist of, or consist essentially of, appropriate combinations of the disclosed elements, components, features, parts, steps, means, etc, other than those specifically described herein. In addition, this disclosure may include other inventions not presently claimed, but which may be claimed in future.

1. A heater for an aerosol provision device configured to heat an article including aerosol generating material, comprising:
an elongate housing having a housing body, an open end and a closed end; and
a heating element extending in the housing in the direction of a longitudinal axis of the elongate housing,
wherein the housing comprises a deformed portion forming the closed end.

2. The heater of claim 1, wherein the open end defines a base end of the housing, the closed end defines a free end of the housing, and the deformed portion defines the free end.

3. The heater of claim 2, wherein the housing body extends between the base end and the free end, wherein the deformed portion extends from the housing body.

4. The heater of claim 3, wherein the housing body defines an undeformed portion of the housing at the free end and the deformed portion abuts the undeformed portion.

5. The heater of claim 3, wherein the deformed portion comprises at least two deformed sections in abutment with each other to form the closed end.

6. The heater of claim 5, wherein the at least two deformed sections are in abutment with each other at a location intermediate to opposing sides of the housing body.

7. The heater of claim 1, wherein the housing body defines an inner void.

8. The heater of claim 2, wherein the deformed portion converges in a direction from the base end to the free end.

9. The heater of claim 1, wherein the deformed portion defines an apex.

10. The heater of claim 1, wherein the deformed portion comprises a crimped portion.

11. The heater of claim 1, wherein the deformed portion comprises a fold.

12. The heater of claim 1, comprising a seal at the closed end to seal the deformed portion.

13. The heater of claim 1, wherein a cross-section perpendicular to the longitudinal axis of the housing body has the shape of at least one of a regular polygon and an irregular polygon.

14. (canceled)

15. The heater of claim 1, wherein the heating element comprises a heating coil.

16. A heater for use in an aerosol-generating device configured to heat an aerosol generating article to generate an aerosol, comprising:
an elongate housing; and
a heating element in the housing,
wherein the housing has a non-circular cross-section perpendicular to a longitudinal axis of the housing.

17. An aerosol provision device configured to heat an article comprising aerosol generating material, comprising a heater according to claim 1.

18. A system comprising the heater of claim 1, and an article comprising aerosol generating material.

19. A method of forming a heater for an aerosol provision device, comprising:
providing an elongate housing;
inserting a heating element in the elongate housing; and
deforming an end of the housing to form a closed end of the housing.

20. The method of claim 19, wherein the heating element is inserted prior to the end of the housing being deformed.

21. The method of claim 19, wherein the end of the housing is deformed prior to the heating element being inserted in the elongate housing.
